(19) United States
(12) Patent Application Publication
(10) Pub. No.: US 2014/0284146 A1
(43) Pub. Date: Sep. 25, 2014

(54) CONTEXT-AWARE SYSTEM FOR ELEVATOR OPERATION

(71) Applicant: Young-jin Park, Jeollabuk-do (KR)

(72) Inventor: Young-jin Park, Jeollabuk-do (KR)

(21) Appl. No.: 14/349,297

(22) PCT Filed: Nov. 28, 2012
(86) PCT No.: PCT/KR2012/010191

§ 371 Date: May 29, 2014

(30) Foreign Application Priority Data
Dec. 16, 2011 (KR) 10-2011-0136835

(51) Int. Cl. B66B 1/46; B66B 1/24; B66B 3/00

(52) U.S. Cl. CPC B66B 1/468; B66B 3/00; B66B 1/2416
USPC 187/388

(57) ABSTRACT

A context-aware system for elevator operation includes an elevator operable to move up and down, and having an internal operating panel allowing selection of a floor to cause the elevator to stop, floor operating panels to call the elevator, and to indicate both a floor selected from the internal operating panel and a floor where the elevator has been called among other floors, a system control unit to adjust a movement direction and a movement speed of the elevator by detecting the floor selected from the internal operating panel and a floor operating panel from which the elevator has been called among the floor operating panels, and a driving unit to drive to move the elevator by control of the system control unit. Therefore, a user may predict a floor at which the elevator is scheduled to stop, and a movement speed may increase and power consumption may reduce.

### TECHNICAL FIELD

The present disclosure relates to an elevator, and more particularly, to a context-aware system for elevator operation that indicates, on a per-floor elevator operating panel disposed at each level of a building and an internal elevator operating panel disposed inside an elevator, respectively, an elevator operation situation of each floor at which the elevator is scheduled to stop, to support awareness of such situation.

### BACKGROUND ART

An elevator is equipment designed to allow people who entered a building having a plurality of floors to move between each floor of the building conveniently, and is essential to a high rise building.

With the introduction of an elevator to a building, users can easily move between each floor of a building, and as a number of high-rise buildings increases, a high-speed elevator capable of moving to each floor faster than a conventional elevator has been introduced. However, as a number of floors of a building increase, a number of floors at which an elevator stops also have increased in proportion to a number of floors of a building. According to characteristics of elevators, an elevator certainly opens and closes an elevator door at least once when it stops at each floor. Accordingly, when an elevator stops at a particular floor and opens and closes its door, a considerable amount of time is consumed, compared a case in which the elevator travels without stopping. Thus, an increase in a number of floors at which an elevator stops causes a movement speed of the elevator to significantly reduce.

Although a high-speed elevator has been introduced, a high-speed elevator is also not supposed to accelerate or stop abruptly for safety and comfort of passengers. Therefore, when an elevator stops at adjacent floors in succession, even though it is a high-speed elevator, a distance the elevator can accelerate at a high movement speed is not provided, and as a result, a high-speed elevator is difficult to move faster than a general elevator.

### DISCLOSURE

### Technical Problem

An object of the present disclosure is to provide an elevator system that allows a user located at each level of a building to make a decision on whether to take an elevator quickly by indicating all floors, at which the elevator is scheduled to stop, on a plurality of floor operating panels disposed at each level of the building and an internal operating panel disposed inside the elevator respectively to operate the elevator.

### Technical Solution

A context-aware system for elevator operation for achieving the foregoing object includes an elevator operable to move up and down between a plurality of floors inside a building, and having an internal operating panel allowing selection of a floor to cause the elevator to stop, a plurality of floor operating panels disposed on each of the plurality of floors inside the building to call the elevator, and configured to indicate both a floor selected from the internal operating panel and a floor where the elevator has been called among a plurality of other floors, a system control unit to adjust a movement direction and a movement speed of the elevator by detecting the floor selected from the internal operating panel and a floor operating panel from which the elevator has been called among the plurality of floor operating panels, and a driving unit to drive to move the elevator by control of the system control unit.

Each of the plurality of floor operating panels for achieving the foregoing object may include a scheduled stop floor indicator to indicate the floor selected from the internal operating panel among the plurality of floors and the floor where the elevator has been called from the plurality of floor operating panels disposed on each of the plurality of floors, an up button to call the elevator going up, a down button to call the elevator going down, and a current floor indicator to indicate a floor at which the elevator is currently located among the plurality of floors.

The scheduled stop floor indicator for achieving the foregoing object may include a plurality of internal lamps provided in multiple numbers corresponding to each of the plurality of floors, and operable to turn on an internal lamp corresponding to the floor selected from the internal operating panel among the plurality of floors, and a plurality of external lamps provided in multiple numbers corresponding to each of the plurality of floors, and operable to turn on an external lamp corresponding to the floor where the floor operating panel from which the elevator has been called is disposed among the plurality of floor operating panels disposed on each of the plurality of floors.

The plurality of external lamps for achieving the foregoing object may be implemented as a button to allow a user to select a destination floor to which the user desires to move.

Each of the plurality of floor operating panels for achieving the foregoing object may further include an internal situation monitor disposed above the current floor indicator to display a video image obtained through a camera installed inside the elevator, and an announcement and advertising monitor to display an announcement or an advertisement.

For each of the plurality of floor operating panels for achieving the foregoing object, the internal situation monitor and the announcement and advertising monitor may display the video image and the announcement or advertisement interchangeably with each other based on a movement direction of the elevator.

The internal operating panel for achieving the foregoing object may include a scheduled stop floor indicator to indicate the floor where the elevator has been called from the plurality of floor operating panels disposed on each of the plurality of floors, and having a plurality of internal selection buttons to allow a user to select a destination floor to which the user desires to move among the plurality of floors, an up and down lamp to indicate a movement direction of the elevator, and a current floor indicator to indicate a floor at which the elevator is currently located among the plurality of floors.

The scheduled stop floor indicator for achieving the foregoing object may include a plurality of internal selection buttons provided in multiple numbers corresponding to each of the plurality of floors to allow the user to select the destination floor to which the user desires to move among the plurality of floors, and a plurality of external lamps provided in multiple numbers corresponding to each of the plurality of floors, and operable to turn on an external lamp corresponding to the floor where the floor operating panel from which the elevator has been called is disposed among the plurality of floor operating panels disposed on each of the plurality of floors.

### Advantageous Effects

Accordingly, a context-aware system for elevator operation according to the present disclosure may allow a user to identify all floors at which an elevator is scheduled to stop through floor operating panels disposed at each level of a building and consequently make a decision on whether to take the elevator quickly. Thus, when a user decides that taking an elevator is unnecessary, the user does not call the elevator to come to a corresponding floor, so an elevator system is provided in which an elevator is allowed to move without stopping at an unnecessary floor. Therefore, not only an average movement speed of an elevator may be improved but also power consumption may reduce. Also, a time spent by users waiting for an elevator unnecessarily may be minimized.

### DESCRIPTION OF DRAWINGS

FIG. 1 illustrates an example of a context-aware system for elevator operation according to the present disclosure.

FIG. 2 illustrates a floor operating panel according to an example of the present disclosure.

FIG. 3 illustrates an internal operating panel according to an example of the present disclosure.

### BEST MODE

A context-aware system for elevator operation for achieving the foregoing object includes an elevator operable to move up and down between a plurality of floors inside a building, and having an internal operating panel allowing selection of a floor to cause the elevator to stop, a plurality of floor operating panels disposed on each of the plurality of floors inside the building to call the elevator, and configured to indicate both a floor selected from the internal operating panel and a floor where the elevator has been called among a plurality of other floors, a system control unit to adjust a movement direction and a movement speed of the elevator by detecting the floor selected from the internal operating panel and a floor operating panel from which the elevator has been called among the plurality of floor operating panels, and a driving unit to drive to move the elevator by control of the system control unit.

Each of the plurality of floor operating panels for achieving the foregoing object may include a scheduled stop floor indicator to indicate the floor selected from the internal operating panel among the plurality of floors and the floor where the elevator has been called from the plurality of floor operating panels disposed on each of the plurality of floors, an up button to call the elevator going up, a down button to call the elevator going down, and a current floor indicator to indicate a floor at which the elevator is currently located among the plurality of floors.

The scheduled stop floor indicator for achieving the foregoing object may include a plurality of internal lamps provided in multiple numbers corresponding to each of the plurality of floors, and operable to turn on an internal lamp corresponding to the floor selected from the internal operating panel among the plurality of floors, and a plurality of external lamps provided in multiple numbers corresponding to each of the plurality of floors, and operable to turn on an external lamp corresponding to the floor where the floor operating panel from which the elevator has been called is disposed among the plurality of floor operating panels disposed on each of the plurality of floors.

The plurality of external lamps for achieving the foregoing object may be implemented as a button to allow a user to select a destination floor to which the user desires to move.

Each of the plurality of floor operating panels for achieving the foregoing object may further include an internal situation monitor disposed above the current floor indicator to display a video image obtained through a camera installed inside the elevator, and an announcement and advertising monitor to display an announcement or an advertisement.

For each of the plurality of floor operating panels for achieving the foregoing object, the internal situation monitor and the announcement and advertising monitor may display the video image and the announcement or advertisement interchangeably with each other based on a movement direction of the elevator.

The internal operating panel for achieving the foregoing object may include a scheduled stop floor indicator to indicate the floor where the elevator has been called from the plurality of floor operating panels disposed on each of the plurality of floors, and having a plurality of internal selection buttons to allow a user to select a destination floor to which the user desires to move among the plurality of floors, an up and down lamp to indicate a movement direction of the elevator, and a current floor indicator to indicate a floor at which the elevator is currently located among the plurality of floors.

The scheduled stop floor indicator for achieving the foregoing object may include a plurality of internal selection buttons provided in multiple numbers corresponding to each of the plurality of floors to allow the user to select the destination floor to which the user desires to move among the plurality of floors, and a plurality of external lamps provided in multiple numbers corresponding to each of the plurality of floors, and operable to turn on an external lamp corresponding to the floor where the floor operating panel from which the elevator has been called is disposed among the plurality of floor operating panels disposed on each of the plurality of floors.

### Mode for Invention

To understand thoroughly the present disclosure, operational advantages of the present disclosure, and objects achieved by carrying out the present disclosure, reference should be made to the accompanying drawings which illustrate preferred embodiments of the present disclosure and all matter set forth in the accompanying drawings.

Hereinafter, the present disclosure will be described in detail by specifying the preferred embodiments of the present disclosure with reference to the accompanying drawings. However, the present disclosure may be implemented in different forms and is not limited to the embodiments described herein. Also, to describe the present disclosure clearly, irrelevant details to the disclosure are omitted herein, and in the drawings, like reference numerals denote like members.

Throughout the specification, it should be understood that the use of the terms “comprises” and/or “comprising”, or “includes” and/or “including” specify the presence of stated components, but do not preclude the presence or addition of one or more other components. Also, the terms “ . . . unit”, “ . . . er/or”, “module”, and “block” as used herein are intended to refer to a unit for processing at least one function or operation, and this may be implemented as hardware or software, or a combination of hardware and software.

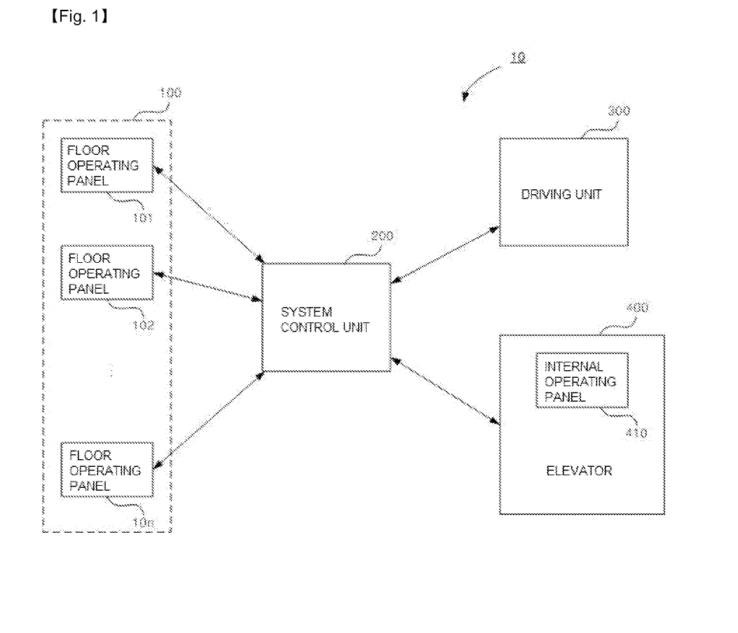

FIG. 1 illustrates an example of a context-aware system for elevator operation according to the present disclosure.

Referring to FIG. 1, a context-aware system 10 for elevator operation according to the present disclosure includes a floor operating unit 100, a system control unit 200, a driving unit 300, and at least one elevator 400. The floor operating unit 100 includes a plurality of floor operating panels 101-10n. The plurality of floor operating panels 101-10n is each disposed at one side of an elevator boarding gate of a corresponding floor in a building including a plurality of floors, and allows a user who desires to take the elevator 400 at each level to call the elevator 400. Because the plurality of floor operating panels 101-10n is arranged, generally, one for each floor of the building, the same number of floor operating panels as a number of floors of the building is equipped, but recently, there are many large and tall buildings and a number of users in such large and tall buildings has increased. Also, when all elevators 400 in a building are set to stop at each floor, usage efficiency of the elevator 400 reduces. In this context, recently, a large and tall building has a plurality of elevators 400, and each elevator is set to stop at different floors. Thus, a number of plural floor operating panels 101-10n may change based on an operation type of an elevator system installed in each building.

Conventionally, a plurality of floor operating panels simply included only an UP direction elevator call button and a DOWN direction elevator call button, and an elevator location indicator indicating a floor number at which an elevator 400 is currently located and whether the elevator 400 is ascending or descending. However, each of the plurality of floor operating panels 101-10n in the context-aware system 10 for elevator operation according to the present disclosure may provide a user with information associated with whether or not the elevator 400 will stop for all floors served by the elevator 400, dissimilar to a conventional elevator system. Accordingly, the user may obtain not only simple information associated with whether the elevator is ascending or descending, but also precise information associated with a floor at which the elevator is going to stop and a number of floors at which the elevator is going to stop. Also, the user who obtained such elevator stop information may determine whether to take the elevator in his/her judgment. For example, there is a high possibility that a user waiting for an elevator at lower floors up to the fifth floor in a high-rise building including twenty floors or more will use stairs rather than waiting for the elevator when the elevator is predicted to stop at all floors between a floor at which the user is waiting for the elevator and a floor at which the elevator is currently located, even though the elevator is currently located at the eighth floor. However, a conventional elevator merely indicates a current location of an elevator, and does not provide information associated with each floor at which the elevator is scheduled to stop, and thus, users could not predict an arrival time of the elevator and just had to wait for the elevator. Afterward, the users who waited for the elevator gave up taking the elevator and instead used stairs only when a number of floors at which the elevator stops have increased. Consequently, as the users waited for the elevator, the users unnecessarily wasted time, and as the elevator unnecessarily stopped at a floor at which a user does not board the elevator, a movement speed of the elevator became lower and lower.

However, the elevator system 10 according to the present disclosure allows each of the plurality of floor operating panels 101-10n equipped on each floor to provide a user with information associated with whether or not the elevator 400 will stop for all floors served by the elevator 400, so the user may roughly estimate a time it will take for the elevator 400 to arrive and consequently, make a decision on whether to take the elevator 400 quickly. As a result of the judgment, when the user determines not to take the elevator and uses stairs, the user avoids wasting time unnecessarily and a number of floors at which the elevator 400 stops reduces, as a consequence, the elevator 400 moves faster. That is, not only a user who intends to take the elevator 400 but also users who have boarded the elevator may reduce wasted time. Also, because the elevator does not stop unnecessarily, power consumption for driving the elevator may reduce.

Although the foregoing disclosure describes that a user determines whether to take the elevator 400 based on an estimated arrival time of the elevator 400, because each of the plurality of floor operating panels 101-10n provides information associated with all floors at which the elevator may stop, a user may estimate a time it will take for the elevator 400 to reach a floor, that is, a destination floor, at which the user desires to arrive after boarding the elevator, as well as an arrival time of the elevator 400. For example, in the case where a user waits for an elevator to move from the tenth floor to the fifth floor, even though the elevator is currently located at the thirteenth floor and is not requested to stop at any floor between the eleventh floor and the thirteenth floor, there is a high possibility that the user will not board the elevator if indication tells that the elevator will stop at all floors between the tenth floor at which the user is about to board the elevator and the fifth floor or a destination floor. This judgment may change according to situations of each user, but nevertheless, the context-aware system for elevator operation according to the present disclosure is useful in that the context-aware system for elevator operation provides a basis of decision about how a user can spend his/her time in person. For example, a user having no time to spare will take stairs, and a user having some time to spare or a physically disabled user will wait for an elevator. That is, a user may determine whether or not to take an elevator himself/herself based on whether the user is more concerned with time or convenience.

A detailed description of the plurality of floor operating panels 101-10n will be provided below.

The system control unit 200 receives an elevator call signal from each of the plurality of floor operating panels 101-10n and an elevator operating signal from an internal operating panel 410 equipped inside each of the at least one elevator 400, and controls upward and downward movements and a stop of the elevator 400 through the driving unit 300. That is, the system control unit 200 receives a signal generated based on an operation state input on the plurality of floor operating panels 101-10n and the internal operating panel 410 from a user, determines an elevator operation including a movement direction and a stop of the elevator 400 by analyzing the signal, and controls the driving unit 300 to perform the determined elevator operation.

The driving unit 300 is implemented as a large motor that drives by the control of the system control unit 200. The driving unit 300 moves the elevator 400 up or down by rotating the motor in one direction or the other direction, and stops the elevator 400, in response to the drive signal applied from the system control unit 200.

The system control unit 200 not only adjusts the elevator 400 to ascend, descend and stop, but also regulates a speed at which the elevator travels up and down for convenience of a user who has boarded the elevator 400. That is, the driving unit 300 controls a rotation speed of the motor by the control of the system control unit 200.

The elevator 400 moves up and down between each floor of the building by the driving unit 300 which drives by the system control unit 200. Also, when the driving unit 300 stops the elevator 400 at a designated floor, the driving unit 300 drives a door (not shown) of the elevator to open and close. Also, when a user selects at least one button among a plurality of floor buttons equipped on the internal operating panel 410, information associated with a selected floor is transmitted to the system control unit 200 to allow the system control unit 200 to control the driving unit 300.

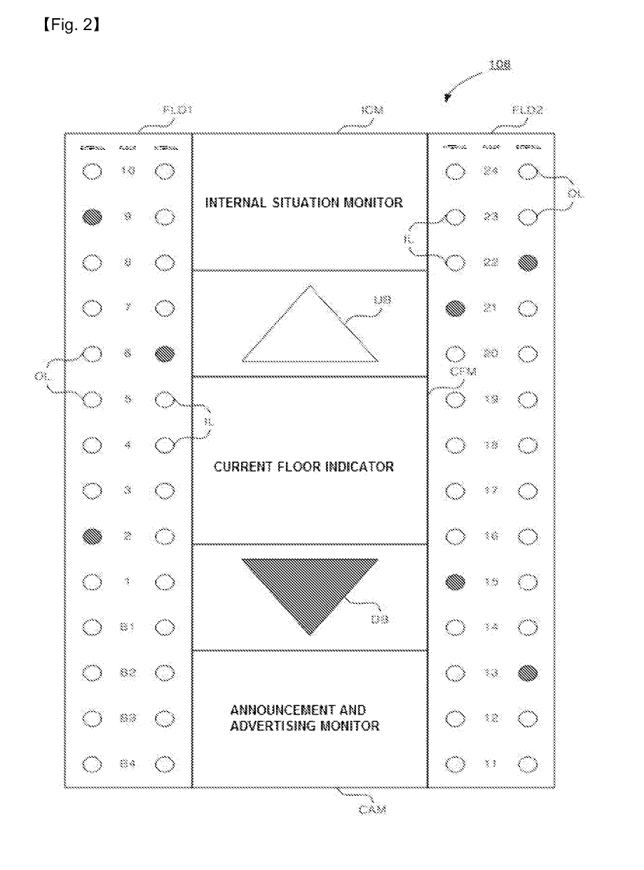

FIG. 2 illustrates the floor operating panel according to an example of the present disclosure.

Referring to FIG. 2, the floor operating panel 108 according to the present disclosure includes at least one scheduled stop floor indicator (FLD), an internal situation monitor (ICM), an UP button (UB) and a DOWN button (DB), a current floor indicator (CFM), and an announcement and advertising monitor (CAM). Although FIG. 2 shows only one floor operating panel 108 provided at the fourth floor as an example, the floor operating panels 101-10n may be provided on all floors served by the elevator, as described in the foregoing.

Each of the at least one scheduled stop floor indicator (FLD) has a plurality of external lamps (OL) and a plurality of internal lamps (IL). The plurality of external lamps (OL) and the plurality of internal lamps (IL) may be provided in a corresponding number to a number of floors served by the elevator 400. Also, in the case where a number of floors served by the elevator 400 are plural, the scheduled stop floor indicator (FLD) is provided in multiple numbers and the plurality of scheduled stop floor indicators (FLDs) is distinguished to indicate each corresponding floor. In FIG. 2, an example of the floor operating panel 101 having two scheduled stop floor indicators (FLDs) is illustrated.

A first scheduled stop floor indicator (FLD1) at the left side indicates scheduled stop floors from the fourth basement level (B4) to the tenth floor in the elevator which serves a total of twenty eight floors from the fourth basement level (B4) to the twenty fourth floor, and a second scheduled stop floor indicator (FLD2) at the right side indicates scheduled stop floors from the eleventh floor to the twenty fourth floor. In FIG. 2, assume that a number of floors of a building is a total of twenty eight floors from the fourth basement level (B4) to the twenty fourth floor, and an elevator serves all the floors. Accordingly, it is assumed that floor operating panels 101-128 are provided on each of the twenty eight floors served by the elevator.

Also, the scheduled stop floor indicators (FLD1, FLD2) indicate scheduled stop floors by classifying the scheduled stop floors into an internal selection floor and an external selection floor for each corresponding floor of the plurality of floors. Here, the internal selection floor represents a floor selected from the internal operating panel 410 inside the elevator 400, and the external selection floor represents a floor selected from the plurality of floor operating panels 101-128.

The internal selection floor indicates only a floor selected from the internal operating panel 410 inside the elevator 400, whereas the external selection floor indicates all floors collected by selection from each of the plurality of floor operating panels 101-128.

Referring to FIG. 2, the lamp of the internal selection floor is turned on for the sixth floor, the fifteenth floor, and the twenty first floor. Accordingly, floors selected by passengers of the elevator are now three floors of the sixth floor, the fifteenth floor, and the twenty first floor. But, the lamp of the external selection floor is turned on for four floors of the second floor, the ninth floor, the thirteenth floor, and the twenty second floor. This implies that four floor operating panels 106, 110, 113, 117, and 126 among the plurality of floor operating panels 101-128 are selected by users who are waiting for the elevator at the second floor, the ninth floor, the thirteenth floor, and the twenty second floor.

Each of the UP button (UB) and the DOWN button (DB) corresponds to a button which a user at a corresponding floor selects based on whether the user intends to move to a higher or lower floor than a current floor, and performs the same function as a floor operating unit of a conventional elevator system. Also, the UP button (UB) and the DOWN button (DB) may have a lamp inside to indicate whether the elevator is currently ascending or descending. Also, because an UP button (UB) is unnecessary on a top floor (twenty fourth floor in FIG. 2) among floors to which the elevator may move, the floor operating panel 128 may have only a DOWN button (DB). Also, because a DOWN button (DB) is unnecessary on a bottom floor (B4 in FIG. 2) among floors to which the elevator may move, the floor operating panel 101 may have only an UP button (UB).

The current floor indicator (CFM) indicates a floor at which the elevator is currently located among the plurality of floors. The current floor indicator (CFM) may simply indicate only a current floor, but may indicate a movement direction of the elevator together. That is, the current floor indicator (CFM) may indicate that the elevator is ascending or descending together. If the current floor indicator (CFM) may indicate that the elevator is ascending or descending, the UP button (UB) and the DOWN button (DB) do not need to indicate a movement direction separately.

The internal situation monitor (ICM) and the announcement and advertising monitor (CAM) are not an indispensable element of the floor operating panel 101 according to the present disclosure, and are a sort of option. The internal situation monitor (ICM) corresponds to an area on which a video image obtained through a camera installed inside the elevator is displayed, and is a monitor for notifying an accident that may occur inside the elevator to the outside world. Also, the announcement and advertising monitor (CAM) displays an announcement or an advertisement intended to provide to a user who is going to board the elevator.

The internal situation monitor (ICM) and the announcement and advertising monitor (CAM) may change their locations each other, and according to circumstances, content being displayed on the internal situation monitor (ICM) and the announcement and advertising monitor (CAM) may change depending on a movement direction of the elevator. For example, when the elevator is ascending, the internal situation monitor (ICM) disposed at an upper part of the floor operating panel 108 may be set to display an announcement and an advertisement, and when the elevator is descending, the announcement and advertising monitor (CAM) disposed at a lower part of the floor operating panel 108 may be set to display an announcement and an advertisement.

On the floor operating panel 108 of FIG. 2, the fourth floor is not currently selected on both the external selection floor and the internal selection floor of the scheduled stop floor indicator (FLD1). Accordingly, it may be detected that there is currently no user who is going to take the elevator at the fourth floor. However, in the case where a new user intends to take the elevator at the fourth floor and move to the tenth floor, if the current floor indicator (CFM) of the elevator indicates the first floor, the user may predict that the elevator will stop at the second floor and then reach the fourth floor, and that the user will take the elevator at the fourth floor and after stopping at the sixth floor and the ninth floor, arrive at the tenth floor. Therefore, the user may estimate a time it will take and make a decision on whether to use stairs or wait for the elevator.

Although FIG. 2 shows the scheduled stop floor indicators (FLD1, FLD2) of the floor operating panels 101-128 indicate scheduled stop floors by classifying the scheduled stop floors into an internal selection floor selected by the internal operating panel 410 and an external selection floor selected from the plurality of floor operating panels 101-128, a scheduled stop floor may be indicated without sorting it into an internal selection floor and an external selection floor.

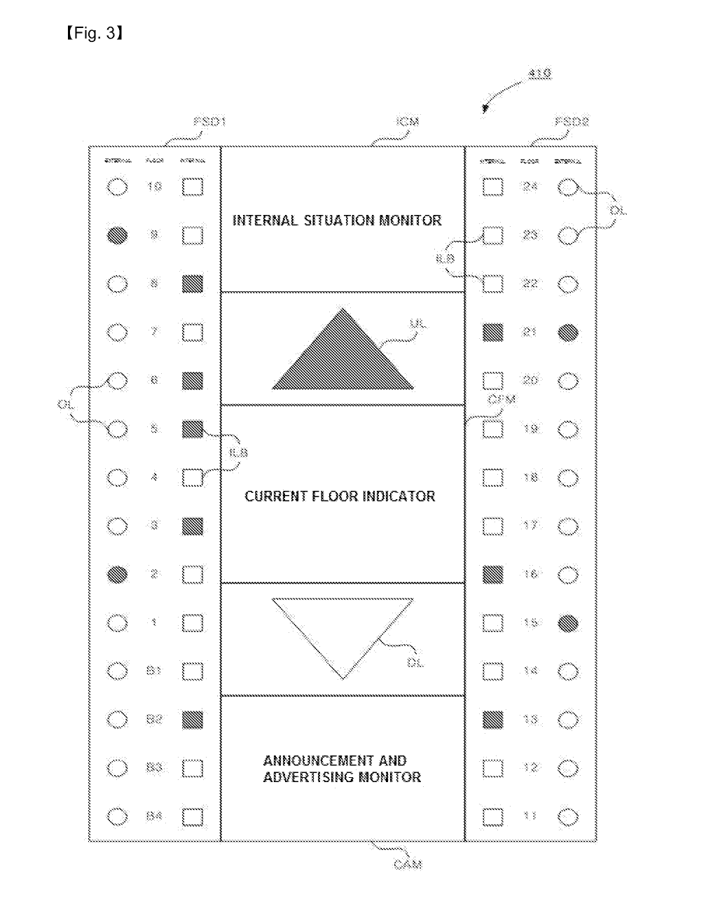

FIG. 3 illustrates the internal operating panel according to an example of the present disclosure.

The internal operating panel 410 disposed inside the elevator 400 in the present disclosure may have the same configuration as a conventional internal operating panel, but is a component provided for convenience of a user who has boarded an elevator.

Referring to FIG. 3, the internal operating panel 410 according to the present disclosure has a similar configuration to the floor operating panels 101-10n of FIG. 2. The internal operating panel 410 includes at least one scheduled stop floor selection indicator (FSD), an internal situation monitor (ICM), an UP lamp (UL) and a DOWN lamp (DL), a current floor indicator (CFM), and an announcement and advertising monitor (CAM).

In FIG. 3, the scheduled stop floor selection indicator (FSD1, FSD2) is also classified into two scheduled stop floor selection indicators (FSD1, FSD2) of a first scheduled stop floor selection indicator (FSD1) and a second scheduled stop floor selection indicator (FSD2) due to many floors at which the elevator stops, similar to the scheduled stop floor indicators (FLD1, FLD2) of FIG. 2. Also, each of the scheduled stop floor selection indicators (FSD1, FSD2) includes a plurality of external lamps (OLs) and a plurality of internal selection buttons (ILBs). Because the plurality of external lamps (OLs) is the same as the external lamps (OLs) of FIG. 2, its description is not separately provided. However, because the internal operating panel 410 should allow a user who has boarded the elevator to directly input a destination floor to which the user intends to move, the internal operating panel 410 of FIG. 3 includes an internal selection button (ILB) rather than an internal lamp (IL) dissimilar to the floor operating panels 101-10n of FIG. 2. The internal selection button (ILB) allows a user who has boarded the elevator to select a floor to which the user desires to move, and indicates floors selected inside the elevator currently. For this, the internal selection button (ILB) may have a lamp inside. Also, although not shown, the floor operating panels 101-10n may also have an external selection button (OLB) rather than an external lamp (OL), according to circumstances. This may allow a user to estimate a movement time of the elevator more precisely by allowing the user to directly input a destination floor at a floor where the user is waiting for the elevator. In this instance, the input destination floor may be indicated on the external selection button (OLB) of the scheduled stop floor indicators (FLD1, FLD2) for each of the plurality of floor operating panels.

The current floor indicator (CFM), the internal situation monitor (ICM), and the announcement and advertising monitor (CAM) are the same as the current floor indicator (CFM), the internal situation monitor (ICM), and the announcement and advertising monitor (CAM) of the floor operating panels 101-10n of FIG. 2, and thus its description is not provided separately.

The UP lamp (UL) and the DOWN lamp (DL) are lamps indicating that the elevator is currently ascending or descending. On the floor operating panels 101-10n, a user selects the UP button (UB) and the DOWN button (DB) based on whether to take an ascending elevator or a descending elevator, and for this reason, the UP lamp (UL) and the DOWN lamp (DL) are implemented in a shape of a button, however because inside the elevator, the user selects an internal selection button (ILB) corresponding to a destination floor, the UP button (UB) and the DOWN button (DB) do not need to be implemented as an UP button (UB) or a DOWN button (DB). That is, as long as it is possible to indicate whether the elevator 400 is ascending or descending, any type will do, and in FIG. 3, it is implemented as a lamp such as the UP lamp (UL) and the DOWN lamp (DL). Also, in the case where the current floor indicator (CFM) indicates a movement direction as well as a current floor of the elevator, the UP lamp (UL) and the DOWN lamp (DL) may be omitted.

Additionally, in the case where the floor operating panels 101-10n of FIG. 2 have an internal selection button (ILB) rather than an internal lamp (IL), an UP lamp (UL) and a DOWN lamp (DL) may be equipped instead of the UP button (UB) or the DOWN button (DB) as shown in FIG. 3.

Therefore, because the context-aware system for elevator operation according to the present disclosure has the floor operating panels 101-10n provided on each floor served by the elevator, not only including the UP button (UB) and the DOWN button (DB) and the current floor indicator, but also including the scheduled stop floor indicator (FLD) to indicate all floors at which the elevator is schedule to stop, the context-aware system for elevator operation allows a user who intends to take the elevator to estimate an arrival time of the elevator and a time it will take to arrive at a destination and determine whether to take the elevator quickly. Thus, the user does not need to waste time unnecessarily. Also, because the elevator does not need to stop unnecessarily, the elevator may move faster and power consumption may reduce.

While the present disclosure has been described with reference to the embodiments shown in the drawings, this is just illustrative and those having ordinary skill in the art will understand that many changes and other embodiments equivalent thereto may be contemplated therefrom.

Therefore, the true scope of technical protection of the present disclosure shall be defined by the technical spirit of the appended claims.

1. A context-aware system for elevator operation, comprising:
an elevator operable to move up and down between a plurality of floors inside a building, and having an internal operating panel allowing selection of a floor to cause the elevator to stop;
a plurality of floor operating panels disposed on each of the plurality of floors inside the building to call the elevator, and configured to indicate both a floor selected from the internal operating panel and a floor where the elevator has been called among a plurality of other floors;
a system control unit to adjust a movement direction and a movement speed of the elevator by detecting the floor selected from the internal operating panel and a floor operating panel from which the elevator has been called among the plurality of floor operating panels; and
a driving unit to drive to move the elevator by control of the system control unit.

2. The context-aware system for elevator operation according to claim 1, wherein each of the plurality of floor operating panels comprises:
a scheduled stop floor indicator to indicate the floor selected from the internal operating panel among the plurality of floors and the floor where the elevator has been called from the plurality of floor operating panels disposed on each of the plurality of floors;
an up button to call the elevator going up;
a down button to call the elevator going down; and
a current floor indicator to indicate a floor at which the elevator is currently located among the plurality of floors.

3. The context-aware system for elevator operation according to claim 2, wherein the scheduled stop floor indicator comprises:
a plurality of internal lamps provided in multiple numbers corresponding to each of the plurality of floors, and operable to turn on an internal lamp corresponding to the floor selected from the internal operating panel among the plurality of floors; and
a plurality of external lamps provided in multiple numbers corresponding to each of the plurality of floors, and operable to turn on an external lamp corresponding to the floor where the floor operating panel from which the elevator has been called is disposed among the plurality of floor operating panels disposed on each of the plurality of floors.

4. The context-aware system for elevator operation according to claim according to claim 2, wherein the plurality of external lamps are implemented as a button to allow a user to select a destination floor to which the user desires to move.

5. The context-aware system for elevator operation according to claim according to claim 2, wherein each of the plurality of floor operating panels further comprises:
an internal situation monitor disposed above the current floor indicator to display a video image obtained through a camera installed inside the elevator; and
an announcement and advertising monitor to display an announcement or an advertisement.

6. The context-aware system for elevator operation according to claim according to claim 5, wherein for each of the plurality of floor operating panels, the internal situation monitor and the announcement and advertising monitor display the video image and the announcement or advertisement interchangeably with each other based on a movement direction of the elevator.

7. The context-aware system for elevator operation according to claim according to claim 2, wherein the internal operating panel comprises:
a scheduled stop floor indicator to indicate the floor where the elevator has been called from the plurality of floor operating panels disposed on each of the plurality of floors, and having a plurality of internal selection buttons to allow a user to select a destination floor to which the user desires to move among the plurality of floors;
an up and down lamp to indicate a movement direction of the elevator; and
a current floor indicator to indicate a floor at which the elevator is currently located among the plurality of floors.

8. The context-aware system for elevator operation according to claim according to claim 7, wherein the scheduled stop floor indicator comprises:
a plurality of internal selection buttons provided in multiple numbers corresponding to each of the plurality of floors to allow the user to select the destination floor to which the user desires to move among the plurality of floors; and
a plurality of external lamps provided in multiple numbers corresponding to each of the plurality of floors, and operable to turn on an external lamp corresponding to the floor where the floor operating panel from which the elevator has been called is disposed among the plurality of floor operating panels disposed on each of the plurality of floors.
